(19) United States
(12) Patent Application Publication
(10) Pub. No.: US 2017/0001532 A1
(43) Pub. Date: Jan. 5, 2017

(54) POWER RECEPTION DEVICE AND VEHICLE INCLUDING THE SAME

(71) Applicant: TOYOTA JIDOSHA KABUSHIKI KAISHA, Toyota-shi, Aichi-ken (JP)

(72) Inventor: Satoshi TANIGUCHI, Toyota-shi, Aichi-ken (JP)

(73) Assignee: TOYOTA JIDOSHA KABUSHIKI KAISHA, Toyota-shi, Aichi-ken (JP)

(21) Appl. No.: 15/107,343

(22) PCT Filed: Dec. 2, 2014
(86) PCT No.: PCT/JP2014/006026

§ 371 Date: Jun. 22, 2016

(30) Foreign Application Priority Data
Dec. 27, 2013 (JP) 2013-271318

(51) Int. Cl. B60L 11/18; H02J 50/90; H02J 50/12; G01B 7/31; H02J 7/02

(52) U.S. Cl. CPC B60L 11/1831; G01B 7/31; H02J 7/025; H02J 50/12; H02J 50/90

(57) ABSTRACT

When a distance between coils is detected, a measuring device measures a power reception voltage VR. A notifying device notifies the distance between the coils based on a measurement result by the measuring device. A power reception unit is configured such that a characteristic of power reception voltage VR with respect to the distance between the coils has a plurality of extreme values in accordance with change in the distance between the coils. When a local minimum value of power reception voltage VR is detected during execution of alignment, a vehicle ECU controls the notifying device to notify the distance between the coils corresponding to the detected local minimum value of power reception voltage VR, by using the characteristic of power reception voltage VR prepared preliminarily.

### TECHNICAL FIELD

The present invention relates to a power reception device and a vehicle including the same, and particularly to a power reception device which is mounted on a vehicle and receives, in a contactless manner, electric power output from a power transmission device provided outside the vehicle, and the vehicle including the power reception device.

### BACKGROUND ART

International Publication No. WO2010/052785 (PTL 1) discloses a technique for controlling parking, at a power transmission device, of a vehicle having mounted thereon a power reception device that receives electric power from the power transmission device in a contactless manner. According to this parking control technique, parking control of the vehicle is executed in two stages. In a first stage, the vehicle is guided to the power transmission device based on a result of image recognition by a camera. In a second stage, a distance between a power transmission coil and a power reception coil is estimated based on a state of power supply (typically a power reception voltage) from the power transmission coil of the power transmission device to the power reception coil of the vehicle, and alignment of the power reception coil with the power transmission coil is executed based on the estimated distance (refer to PTL 1).

### CITATION LIST

### Patent Literature

[PTL 1] International Publication No. WO2010/052785

[PTL 2] Japanese Patent Laying-Open No. 2011-254633

[PTL 3] Japanese Patent Laying-Open No. 2013-154815

[PTL 4] Japanese Patent Laying-Open No. 2013-146154

[PTL 5] Japanese Patent Laying-Open No. 2013-146148

[PTL 6] Japanese Patent Laying-Open No. 2013-110822

[PTL 7] Japanese Patent Laying-Open No. 2013-126327

### SUMMARY OF INVENTION

### Technical Problem

In order to enhance the efficiency of power transfer from the power transmission coil to the power reception coil, it is necessary to execute alignment of the power reception coil with the power transmission coil (hereinafter simply referred to as “alignment”). In the vehicle having mounted thereon the power reception device that receives electric power from the power transmission device in a contactless manner, alignment can be executed based on the distance between the power transmission coil and the power reception coil (hereinafter referred to as “distance between the coils”) estimated based on the power reception voltage of the power reception coil, as described in PTL 1 above.

Alignment may be executed by automatic control based on the distance between the coils, or may be executed manually by a user notified of the distance between the coils. Alternatively, the user may be notified of the distance between the coils and the user may perform only the stop operation of the vehicle based on this distance information. In any of these cases, in order to execute highly-accurate alignment to enhance the power transfer efficiency, it is important to detect the distance between the coils with a high degree of accuracy and notify the user of the distance between the coils.

The present invention has been made to solve the aforementioned problem, and an object of the present invention is to provide a power reception device that can notify a user of highly-accurate information about a distance between a power transmission coil and a power reception coil.

### Solution to Problem

According to the present invention, a power reception device is a power reception device which is mounted on a vehicle and receives, in a contactless manner, electric power output from a power transmission device provided outside the vehicle, and the power reception device includes: a power reception coil; a measuring device; a notifying device; and a control device. The power reception coil is configured to receive, in a contactless manner, the electric power output from a power transmission coil of the power transmission device. The measuring device is for, when a distance between the coils is detected based on a power reception voltage at the time of the power reception coil's reception of the electric power output from the power transmission coil, measuring the power reception voltage. The notifying device notifies the distance between the coils based on a measurement result by the measuring device. The power reception coil is configured such that a characteristic of the power reception voltage with respect to the distance between the coils has a plurality of extreme values in accordance with change in the distance between the coils. When a local minimum value of the power reception voltage is detected based on the measurement result by the measuring device, the control device controls the notifying device to notify the distance between the coils corresponding to the detected local minimum value of the power reception voltage, by using the characteristic of the power reception voltage prepared preliminarily.

In this power reception device, the power reception coil is configured such that the characteristic of the power reception voltage with respect to the distance between the coils has a plurality of extreme values in accordance with change in the distance between the coils. When the local minimum value of the power reception voltage is detected based on the measurement result by the measuring device, the notifying device notifies the user of the distance between the coils corresponding to this local minimum value of the power reception voltage. The distance between the coils when the power reception voltage has the local minimum value is specific to the configuration of the power reception coil and can be detected with a high degree of accuracy based on the power reception voltage characteristic preliminarily obtained with respect to the distance between the coils. Therefore, according to this power reception device, the user can be notified of highly-accurate information about the distance between the coils.

Preferably, the measuring device includes: a resistance unit; and a voltage sensor. A current generated at the power reception coil at the time of reception of the electric power from the power transmission coil flows through the resistance unit. The voltage sensor detects a voltage generated at the resistance unit. A resistance value of the resistance unit is switchable between a first resistance value and a second resistance value which is smaller than the first resistance value. In the case of moving the vehicle and executing alignment based on the distance between the coils, the resistance value of the resistance unit is set at the second resistance value until the local minimum value of the power reception voltage is at least detected based on the measurement result by the measuring device.

By setting the resistance value of the resistance unit to be small, the impedance of the power reception device becomes small and the power reception characteristic at a distant location is improved. In this power reception device, during execution of the alignment, the resistance value of the resistance unit is set at the second resistance value smaller than the first resistance value until the local minimum value of the power reception voltage is at least detected. Therefore, according to this power reception device, wide-range measurement of the distance between the coils is possible.

More preferably, when the distance between the coils is detected during movement of the vehicle with execution of the alignment, the resistance value of the resistance unit is set at the second resistance value. When the distance between the coils is detected during stop of the vehicle, the resistance value of the resistance unit is set at the first resistance value.

As for relation between a coupling coefficient and the transfer efficiency between the coils, it is known that as the resistance value of the resistance unit becomes larger, the transfer efficiency becomes higher when the coupling coefficient is large. When the distance between the coils is short (the coupling coefficient is large), position displacement between the coils can be detected more accurately when the resistance value of the resistance unit is large. Thus, in this power reception device, during movement of the vehicle with execution of the alignment, the resistance value of the resistance unit is set at the second resistance value, and during stop of the vehicle after the end of the alignment, the resistance value of the resistance unit is set at the first resistance value larger than the second resistance value. As a result, wide-range measurement of the distance between the coils is possible, and the user can be notified of highly-accurate information about the distance between the coils even when the distance between the coils is short (during stop of the vehicle after the end of the alignment).

More preferably, during execution of the alignment, the resistance value of the resistance unit is set at the second resistance value. When the distance between the coils is detected after the end of the alignment, the resistance value of the resistance unit is set at the first resistance value.

According to this power reception device, wide-range measurement of the distance between the coils is possible, and the user can be notified of highly-accurate information about the distance between the coils even when the distance between the coils after the end of the alignment is short.

More preferably, when the local minimum value of the power reception voltage is detected based on the measurement result by the measuring device during execution of the alignment, the resistance value of the resistance unit is set at the first resistance value.

In this power reception device, when the local minimum value of the power reception voltage is detected as the distance between the coils becomes shorter, during execution of the alignment, the resistance value of the resistance unit is set at the first resistance value larger than the second resistance value. Therefore, according to this power reception device as well, wide-range measurement of the distance between the coils is possible, and the user can be notified of highly-accurate information about the distance between the coils even when the distance between the coils is short.

Preferably, the resistance unit includes: a first resistor; and a second resistor. The first resistor has the first resistance value. The second resistor has the second resistance value, and the second resistor and the first resistor are selectively used.

According to this power reception device, simply by switching the resistors of the resistance unit, wide-range measurement of the distance between the coils is possible, and the user can be notified of highly-accurate information about the distance between the coils even when the distance between the coils is short.

Preferably, the number of the extreme values when the resistance value of the resistance unit is the second resistance value is larger than the number of the extreme values when the resistance value of the resistance unit is the first resistance value.

When the resistance value of the resistance unit is small, a plurality of extreme values are further generated in a range smaller than the distance between the coils corresponding to the local minimum value of the power reception voltage described above, and thus, it is difficult to specify the distance between the coils based on the power reception voltage. According to this power reception device, the resistance value of the resistance unit is switched to the first resistance value after the local minimum value of the power reception voltage is detected. Therefore, even in the range where the distance between the coils is short, the distance between the coils can be detected accurately.

Preferably, the power reception coil includes: a winding; and a core around which the winding is wound. The power reception coil is mounted on the vehicle such that a winding axis of the winding extends along a frontward-rearward direction of the vehicle.

In the aforementioned configuration of the power reception coil, in accordance with the relative positional relation between the power transmission coil and the power reception coil, there is a point where the magnetic field of the power reception coil is reversed as the distance between the coils becomes shorter, and the local minimum value of the power reception voltage is generated at this position. This point is unambiguously defined by the size of the coils and the relative positional relation between the coils. Therefore, according to this power reception device, the user can be notified of highly-accurate information about the distance between the coils.

According to the present invention, a vehicle includes any one of the aforementioned power reception devices.

### Advantageous Effects of Invention

According to the present invention, there can be provided a power reception device that can notify a user of highly-accurate information about a distance between a power transmission coil and a power reception coil.

### BRIEF DESCRIPTION OF DRAWINGS

FIG. 1 is an overall configuration diagram of a power transfer system to which a power reception device according to a first embodiment of the present invention is applied.

FIG. 2 is a diagram showing arrangement of a power reception unit when a vehicle is viewed from the side.

FIG. 3 is a diagram showing arrangement of the power reception unit when the vehicle is viewed from above.

FIG. 4 is a diagram showing relation between a distance between coils and a power reception voltage when alignment is executed.

FIG. 5 is a diagram showing a magnetic field formed in a power transmission unit and the power reception unit when the distance between the coils is larger than X3.

FIG. 6 is a diagram showing a magnetic field formed in the power transmission unit and the power reception unit when the distance between the coils is smaller than X3.

FIG. 7 is a first flowchart for describing a procedure for detecting the distance between the coils when alignment is executed.

FIG. 8 is a second flowchart for describing a procedure for detecting the distance between the coils when alignment is executed.

FIG. 9 is a diagram showing relation between a coupling coefficient and a power transfer rate when a resistance value of a resistance of a measuring device is large and when the resistance value of the resistance of the measuring device is small.

FIG. 10 is an overall configuration diagram of a power transfer system to which a power reception device according to a second embodiment is applied.

FIG. 11 is a diagram showing relation between a distance between the coils and a power reception voltage when a resistance value of a measuring device is small.

FIG. 12 is a diagram showing relation between a distance between the coils and a power reception voltage when the resistance value of the measuring device is large.

FIG. 13 is a flowchart for describing a procedure for switching between resistances of the measuring device when alignment is executed.

FIG. 14 is a flowchart for describing a procedure for switching between the resistances of the measuring device in a first modification of the second embodiment.

FIG. 15 is a flowchart for describing a procedure for switching between the resistances of the measuring device in a second modification of the second embodiment.

### DESCRIPTION OF EMBODIMENTS

Embodiments of the present invention will be described in detail hereinafter with reference to the drawings. A plurality of embodiments will be described below, while it is originally intended to combine the configurations described in the embodiments as appropriate. The same or corresponding portions in the drawings are denoted by the same reference characters and description thereof will not be repeated.

### First Embodiment

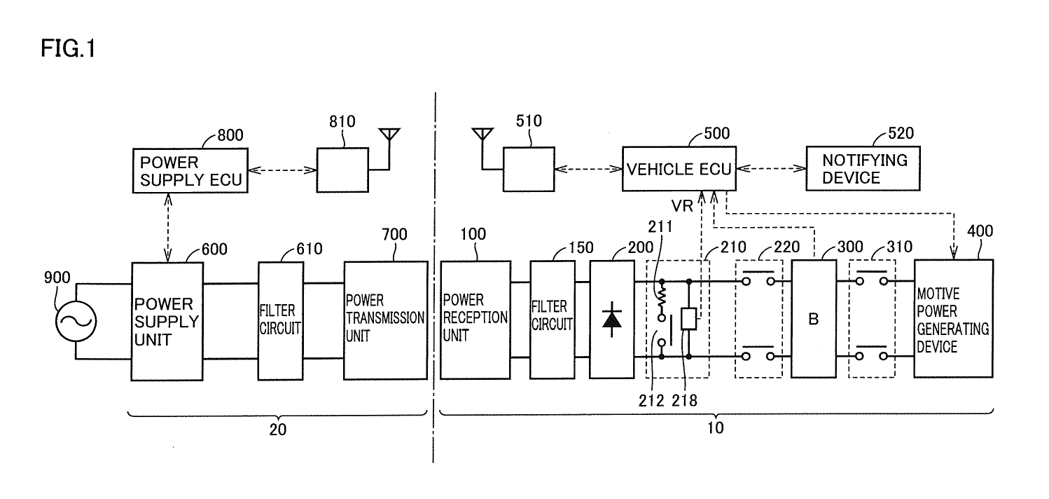

FIG. 1 is an overall configuration diagram of a power transfer system to which a power reception device according to a first embodiment of the present invention is applied. Referring to FIG. 1, the power transfer system according to the first embodiment includes a vehicle 10 and a power transmission device 20. Vehicle 10 includes a power reception unit 100, a filter circuit 150, a rectifying unit 200, a measuring device 210, relays 220 and 310, a power storage device 300, and a motive power generating device 400. Vehicle 10 also includes a vehicle ECU (Electronic Control Unit) 500, a communication device 510 and a notifying device 520.

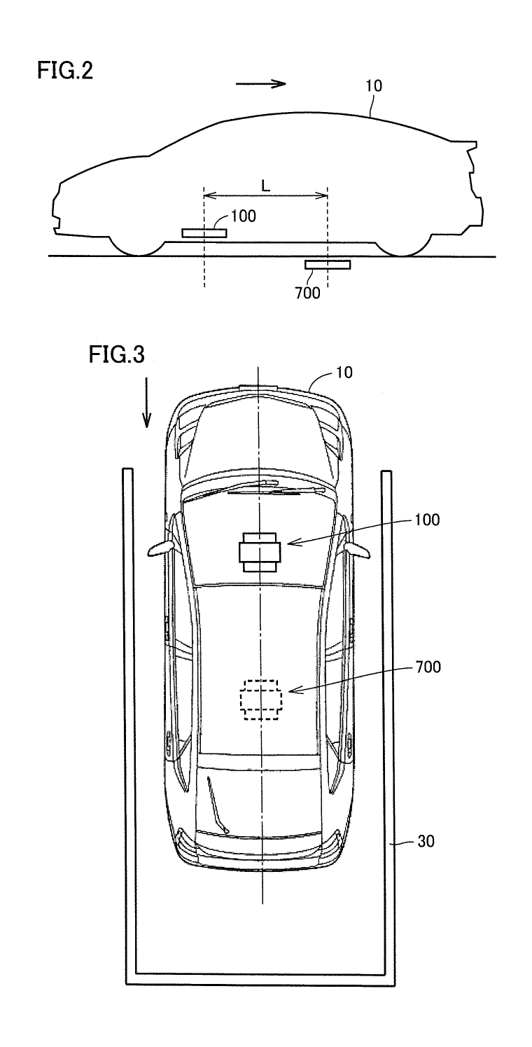

Power reception unit 100 includes a coil for receiving, in a contactless manner, electric power (alternating-current (AC)) output from a power transmission unit 700 (described below) of power transmission device 20. Power reception unit 100 outputs the received electric power to rectifying unit 200. In this first embodiment, as shown in FIGS. 2 and 3, power transmission unit 700 of power transmission device 20 is provided on or in the ground, and power reception unit 100 is provided at the lower part of the vehicle body close to the front part of the vehicle body.

The arrangement location of power reception unit 100 is not limited thereto. For example, power reception unit 100 may be provided at the lower part of the vehicle body close to the rear part of the vehicle body. Alternatively, if power transmission device 20 is provided at the upper part of the vehicle, power reception unit 100 may be provided at the upper part of the vehicle body.

Filter circuit 150 is provided between power reception unit 100 and rectifying unit 200 to reduce harmonic noises generated at the time of power reception from power transmission device 20. Filter circuit 150 is formed, for example, by an LC filter including a plurality of inductors and capacitors. Rectifying unit 200 rectifies the AC power received by power reception unit 100.

When a distance between power transmission unit 700 and power reception unit 100 (distance between the coils) is detected based on a power reception voltage at the time of power reception unit 100's reception of the electric power output from power transmission device 20, measuring device 210 measures the power reception voltage (direct-current (DC)) rectified by rectifying unit 200. Measuring device 210 includes a resistance 211, a relay 212 and a voltage sensor 218. Resistance 211 and relay 212 are provided between a pair of output lines of rectifying unit 200, and are serially connected. Voltage sensor 218 detects a power reception voltage VR generated at resistance 211, and outputs the detection value to vehicle ECU 500. At the time of detection of the distance between the coils, relay 212 is turned on (relay 220 described below is turned off) by vehicle ECU 500, and power reception unit 100 receives the electric power output from power transmission unit 700 for detection of the distance between the coils. As a result, power reception voltage VR generated at resistance 211 is detected by voltage sensor 218. Using this power reception voltage VR, the distance between the coils is detected.

Relay 220 is provided between measuring device 210 and power storage device 300, and is turned on by vehicle ECU 500 when power storage device 300 is charged by power transmission device 20 (when power storage device 300 is charged, relay 212 of measuring device 210 is turned off). As described above, relay 220 is turned off at the time of detection of the distance between the coils.

Power storage device 300 is a rechargeable DC power supply and is formed, for example, by a secondary battery such as a lithium ion secondary battery or a nickel-metal hydride secondary battery. The voltage of power storage device 300 is, for example, approximately 200 V. Power storage device 300 stores the electric power output from rectifying unit 200, and also stores the electric power generated by motive power generating device 400. Power storage device 300 supplies the stored electric power to motive power generating device 400. A large-capacitance capacitor can also be used as power storage device 300. Although not particularly shown, a DC-DC converter for adjusting an output voltage of rectifying unit 200 may be provided between rectifying unit 200 and power storage device 300. Relay 310 is provided between power storage device 300 and motive power generating device 400, and when startup of motive power generating device 400 is requested, relay 310 is turned on by vehicle ECU 500.

Motive power generating device 400 generates the travel driving force of vehicle 10 by using the electric power stored in power storage device 300. Although not particularly shown, motive power generating device 400 includes, for example, an inverter that receives the electric power from power storage device 300, a motor driven by the inverter, a driving wheel driven by the motor, and the like. Motive power generating device 400 may include a generator for charging power storage device 300, and an engine that can drive the generator.

Vehicle ECU 500 includes a CPU (Central Processing Unit), a storage device, an input/output buffer and the like (all are not shown). Vehicle ECU 500 receives signals from various sensors and outputs control signals to the devices, and also controls the devices in vehicle 10. By way of example, vehicle ECU 500 executes control of travel of vehicle 10, control of charging of power storage device 300 by power transmission device 20, and the like.

Furthermore, as main control executed by vehicle ECU 500, vehicle ECU 500 detects the distance between the coils and controls notifying device 520 to notify the detected distance between the coils when alignment of power reception unit 100 with power transmission unit 700 is executed and when alignment checking before the start of charging is executed. Generally, the magnitude of power reception voltage VR measured by measuring device 210 depends on the distance between the coils. A characteristic of power reception voltage VR with respect to the distance between the coils is prepared preliminarily, and using this characteristic of power reception voltage VR with respect to the distance between the coils, vehicle ECU 500 detects the distance between the coils based on power reception voltage VR measured by measuring device 210. A method for detecting and notifying the distance between the coils will be described in detail later.

When the distance between the coils is detected during execution of alignment and during alignment checking, vehicle ECU 500 controls relay 212 to be turned on and controls relay 220 to be turned off. When alignment is completed and power storage device 300 is charged by power transmission device 20, vehicle ECU 500 controls relay 212 to be turned off and controls relay 220 to be turned on. As for relay 310, vehicle ECU 500 turns on relay 310 when movement of vehicle 10 is requested (at the time of normal travel and at the time of execution of alignment).

When alignment is executed and when power storage device 300 is charged by power transmission device 20, vehicle ECU 500 communicates with power transmission device 20 using communication device 510 and exchanges, with power transmission device 20, information about the start/stop of charging, the power reception state of vehicle 10, and the like.

The aforementioned control executed by vehicle ECU 500 is not limited to processing by software and can also be executed by dedicated hardware (electronic circuit).

Notifying device 520 is controlled by vehicle ECU 500 and notifies the user of the distance between the coils detected by vehicle ECU 500 based on power reception voltage VR measured by measuring device 210. Notifying device 520 is typically a display device that visually displays the distance between the coils. However, notifying device 520 may use sound or other means to notify the user.

On the other hand, power transmission device 20 includes a power supply unit 600, a filter circuit 610, a power transmission unit 700, a power supply ECU 800, and a communication device 810. Power supply unit 600 receives electric power from an external power supply 900 such as a commercial system power supply, and generates AC power having a prescribed transmission frequency.

Power transmission unit 700 includes a coil for transmitting electric power to power reception unit 100 of vehicle 10 in a contactless manner. Power transmission unit 700 receives the AC power having the transmission frequency from power supply unit 600, and transmits the power to power reception unit 100 of vehicle 10 in a contactless manner via the electromagnetic field generated around power transmission unit 700.

Filter circuit 610 is provided between power supply unit 600 and power transmission unit 700 to reduce harmonic noises generated from power supply unit 600. Filter circuit 610 is formed, for example, by an LC filter including a plurality of inductors and capacitors.

Power supply ECU 800 includes a CPU, a storage device, an input/output buffer and the like (all are not shown). Power supply ECU 800 receives signals from various sensors and outputs control signals to the devices, and also controls the devices in power transmission device 20. By way of example, power supply ECU 800 executes switching control of power supply unit 600 such that power supply unit 600 generates the AC power having the transmission frequency. The aforementioned control is not limited to processing by software and can also be executed by dedicated hardware (electronic circuit).

When alignment is executed and when the electric power is transmitted to vehicle 10, power supply ECU 800 communicates with communication device 510 of vehicle 10 using communication device 810 and exchanges, with vehicle 10, information about the start/stop of charging, the power reception state of vehicle 10, and the like.

In power transmission device 20, the AC power having the prescribed transmission frequency is supplied from power supply unit 600 through filter circuit 610 to power transmission unit 700. Each of power transmission unit 700 and power reception unit 100 of vehicle 10 includes the coil and the capacitor, and is designed to resonate in the transmission frequency. A Q factor indicating the resonance intensity of power transmission unit 700 and power reception unit 100 is preferably 100 or larger. In each of power transmission unit 700 and power reception unit 100, the capacitor may be serially connected to the coil, or may be connected in parallel to the coil. Alternatively, when a desired resonance frequency can be achieved without including the capacitor, the capacitor is not necessarily required.

When the AC power is supplied from power supply unit 600 through filter circuit 610 to power transmission unit 700, the energy (electric power) moves from power transmission unit 700 to power reception unit 100 via the electromagnetic field formed between the coil of power transmission unit 700 and the coil of power reception unit 100. Then, the energy (electric power) moved to power reception unit 100 is supplied to power storage device 300 through filter circuit 150 and rectifying unit 200.

When the distance between the coils is detected during execution of alignment and during alignment checking, relay 220 is turned off and thereby the electric power is not supplied to power storage device 300, and relay 212 of measuring device 210 is turned on and thereby a voltage corresponding to the received electric power is generated at resistance 211. At this time, the distance between the coils is detected based on power reception voltage VR generated at resistance 211, and is notified by notifying device 520. The electric power output from power transmission device 20 during execution of alignment and during alignment checking is smaller than the electric power output during charging of power storage device 300, and is set to be, for example, 1/100 or less of the electric power output during charging.

Although not particularly shown, in power transmission device 20, an insulating transformer may be provided between power transmission unit 700 and power supply unit 600 (e.g., between power transmission unit 700 and filter circuit 610). In vehicle 10 as well, an insulating transformer may be provided between power reception unit 100 and rectifying unit 200 (e.g., between power reception unit 100 and filter circuit 150).

FIG. 2 is a diagram showing arrangement of power reception unit 100 when vehicle 10 is viewed from the side. FIG. 3 is a diagram showing arrangement of power reception unit 100 when vehicle 10 is viewed from above. Referring to FIGS. 2 and 3, power transmission unit 700 of power transmission device 20 is disposed within a parking frame 30 and vehicle 10 is parked along parking frame 30. In this first embodiment, vehicle 10 is parked rearward. However, vehicle 10 may be parked frontward.

As described above, each of power reception unit 100 and power transmission unit 700 is formed by the coil. Each coil includes a winding and a core around which the winding is wound. Power reception unit 100 is mounted on vehicle 10 such that a winding axis of the winding extends along the frontward-rearward direction of vehicle 10. Power transmission unit 700 is disposed such that a winding axis of the winding extends along the vehicle movement direction within parking frame 30. As shown in FIG. 2, a distance L between the central part of power transmission unit 700 and the central part of power reception unit 100 along the movement direction of vehicle 10 corresponds to “distance between the coils”.

With parking of vehicle 10 in parking frame 30, alignment of power reception unit 100 with power transmission unit 700 is executed. When alignment is executed, the certain electric power for position checking is output from power transmission unit 700, and distance L between the coils is detected based on power reception voltage VR measured by measuring device 210 (FIG. 1). As described above, the electric power for position checking is set to be, for example, 1/100 or less of the electric power output during charging of power storage device 300.

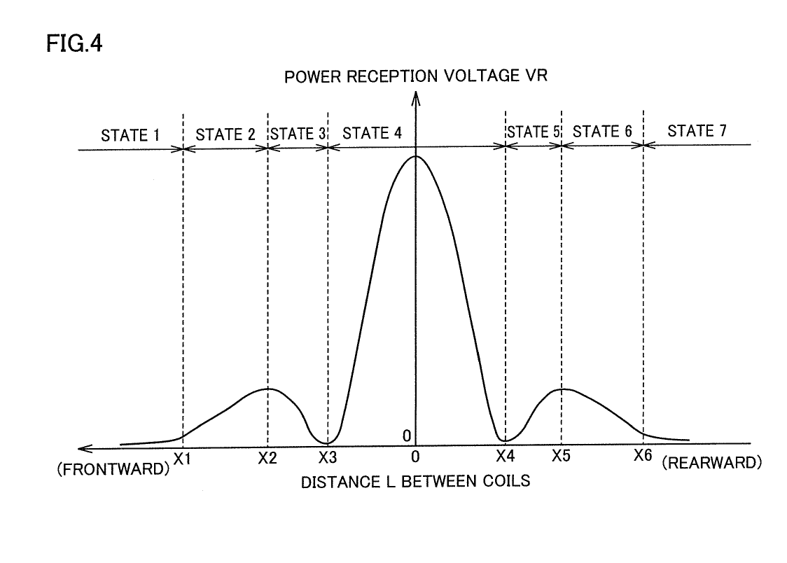

FIG. 4 is a diagram showing relation between distance L between the coils and power reception voltage VR when alignment is executed. Referring to FIG. 4, assuming that a position where power reception unit 100 directly faces power transmission unit 700 is defined as the distance between the coils being 0, “frontward” in the horizontal axis indicative of distance L between the coils means that vehicle 10 is located more frontward than the directly facing position along the vehicle movement direction, and distance L between the coils has a positive value.

Such a case is assumed that vehicle 10 is parked rearward within parking frame 30 (FIG. 3) and alignment between the coils is executed. When distance L between the coils reaches X1, power reception voltage VR starts to increase. Thereafter, as distance L between the coils becomes smaller, power reception voltage VR increases. However, when distance L between the coils is X2 (X2<X1), power reception voltage VR has the local maximum value temporarily. Thereafter, when distance L between the coils is X3 (X3<X2), power reception voltage VR has the local minimum value. Then, power reception voltage VR increases as vehicle 10 moves rearward further, and when distance L between the coils is 0 (directly facing position), power reception voltage VR is maximized.

When distance L between the coils is negative, the similar power reception voltage characteristic is also exhibited. When distance L between the coils is X4, power reception voltage VR has the local minimum value, and when distance L between the coils is X5 (X5<X4), power reception voltage VR has the local maximum value. Thereafter, when distance L between the coils is X6 (X6<X5), power reception voltage VR is substantially 0.

In the following description, the time of distance L between the coils being larger than X1 is defined as “state 1”, and the time of distance L between the coils being smaller than or equal to X1 and larger than X2 is defined as “state 2”. In addition, the time of distance L between the coils being smaller than or equal to X2 and larger than X3 is defined as “state 3”, and the time of distance L between the coils being smaller than or equal to X3 and larger than X4 is defined as “state 4”. Furthermore, the time of distance L between the coils being smaller than or equal to X4 and larger than X5 is defined as “state 5”, and the time of distance L between the coils being smaller than or equal to X5 and larger than X6 is defined as “state 6”. Moreover, the time of distance L between the coils being equal to or smaller than X6 is defined as “state 7”.

Next, description will be given below of the principle of power reception voltage VR having the local minimum value when distance L between the coils is X3 and X4.

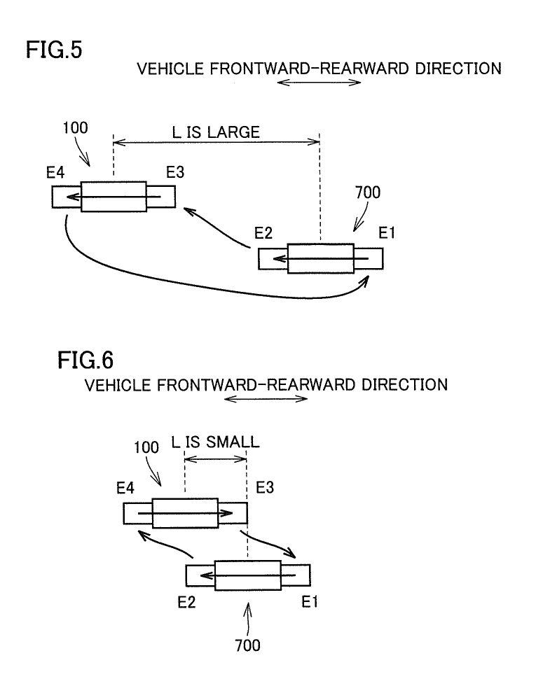

FIG. 5 is a diagram showing a magnetic field formed in power transmission unit 700 and power reception unit 100 when distance L between the coils is larger than X3. FIG. 6 is a diagram showing a magnetic field formed in power transmission unit 700 and power reception unit 100 when distance L between the coils is smaller than X3. The AC magnetic field is generated in power transmission unit 700 and power reception unit 100 in accordance with the AC power generated by power supply unit 600 (FIG. 1). FIGS. 5 and 6 show the state when the magnetic field is formed in the direction from an end E1 toward an end E2 in power transmission unit 700.

Referring to FIG. 5, when distance L between the coils is larger than X3, the magnetic field is formed to travel from end E2 of power transmission unit 700 to an end E3 of power reception unit 100, pass through the core of power reception unit 100 and return from an end E4 of power reception unit 100 to end E1 of power transmission unit 700. The magnetic field in the direction from end E3 toward end E4 is formed in the core of power reception unit 100, and a current corresponding to this direction of the magnetic field is induced in the winding of power reception unit 100.

On the other hand, referring to FIG. 6, when distance L between the coils is smaller than X3, the magnetic field is formed to travel from end E2 of power transmission unit 700 to end E4 of power reception unit 100, pass through the core of power reception unit 100 and return from end E3 of power reception unit 100 to end E1 of power transmission unit 700. The magnetic field in the direction from end E4 toward end E3 is formed in the core of power reception unit 100, and a current corresponding to this direction of the magnetic field is induced in the winding of power reception unit 100.

Referring again to FIG. 4, before and after distance L between the coils reaches X3 and X4, the phase of the current induced in power reception unit 100 is reversed. Therefore, when distance L between the coils is X3 and X4, the electric power received by power reception unit 100 is 0 in principle. In reality, however, due to a smoothing capacitor provided in rectifying unit 200 (FIG. 1), power reception voltage VR measured by measuring device 210 is not 0 and has the local minimum value. As described above, the characteristic of power reception voltage VR with respect to distance L between the coils has a plurality of extreme values in accordance with the change in distance L between the coils.

The magnitude of power reception voltage VR is influenced not only by distance L between the coils but also by fluctuation of a gap between the coils (i.e., fluctuation of the vehicle height) and position displacement in the right-left direction of the vehicle (amount of offset). Therefore, detection of distance L between the coils based on the magnitude of power reception voltage VR exhibits a wide range of variations. On the other hand, the distance between the coils in which power reception voltage VR has the local minimum value (X3, X4) is not influenced by the fluctuation of the gap between the coils and the amount of offset as greatly as the magnitude of power reception voltage VR. Thus, in this first embodiment, the fact that the characteristic of power reception voltage VR with respect to distance L between the coils has the plurality of extreme values is used, and when the extreme value of power reception voltage VR is detected, distance L between the coils corresponding to this extreme value is notified. Particularly, when the local minimum value of power reception voltage VR is detected, distance L between the coils corresponding to this local minimum value is notified.

As for distance L between the coils in between the extreme values, distance L between the coils can be calculated based on a movement distance of the vehicle calculated by summing the number of rotations of the driving wheel or the motor that drives the driving wheel. Preferably, when rising of power reception voltage VR is detected (X1 in FIG. 4), the movement distance from the distance between the coils corresponding to the detection of rising (X1) is calculated and distance L between the coils is notified. When the extreme value (in particular, the local minimum value) of power reception voltage VR is detected, distance L between the coils calculated based on the movement distance may be corrected by the distance between the coils corresponding to this extreme value (in particular, X3).

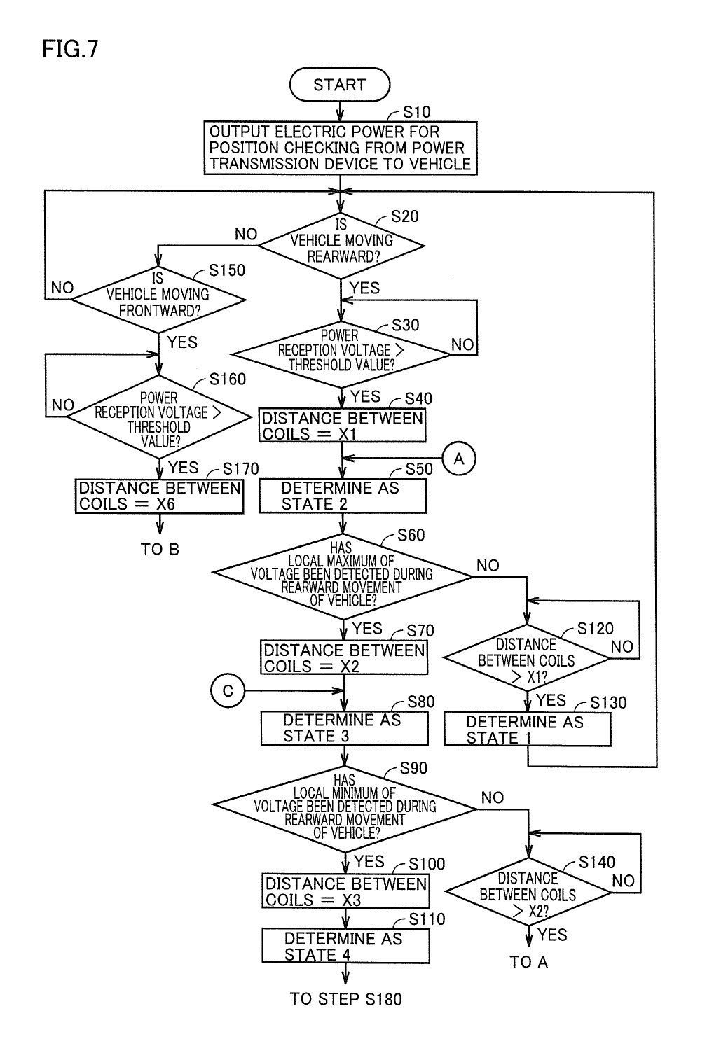

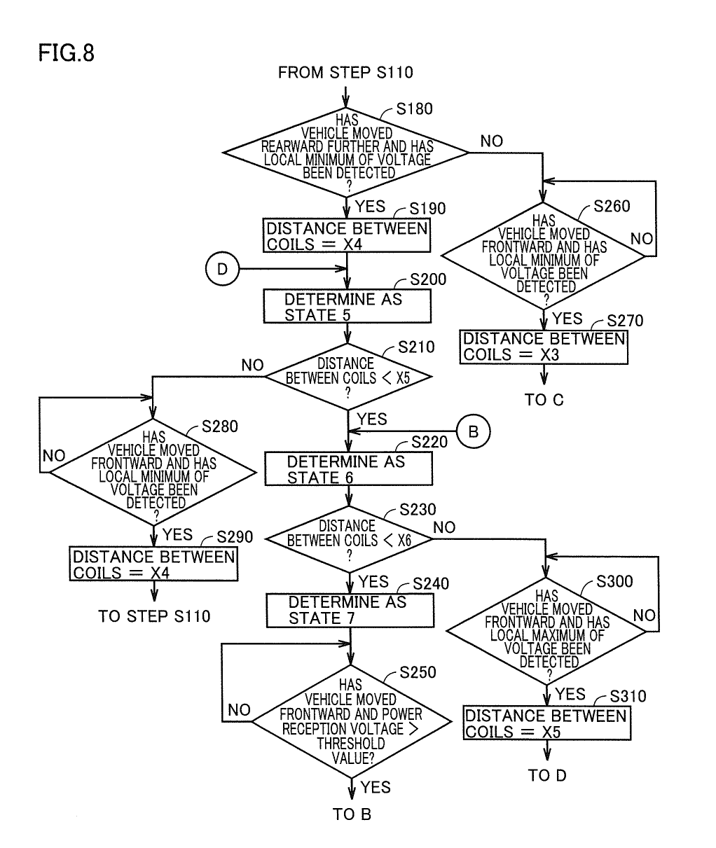

FIGS. 7 and 8 are flowcharts for describing a procedure for detecting distance L between the coils when alignment is executed. The process shown in these flowcharts is started, for example, when a request for outputting the electric power for position checking is sent from vehicle 10 to power transmission device 20, and ends when alignment ends and a request for stopping the electric power for position checking is sent from vehicle 10 to power transmission device 20.

Referring to FIG. 4 together with FIG. 7, if output of the electric power for position checking from power transmission device 20 to vehicle 10 is confirmed (step S10), vehicle ECU 500 determines whether vehicle 10 is moving rearward or not (step S20). If it is determined that vehicle 10 is moving rearward (YES in step S20), vehicle ECU 500 determines whether power reception voltage VR measured by measuring device 210 is higher than a prescribed threshold value or not (step S30). This threshold value is for detecting rising of power reception voltage VR when distance L between the coils is X1. If power reception voltage VR exceeds the threshold value (YES in step S30), vehicle ECU 500 sets distance L between the coils at X1 (step S40) and determines that distance L between the coils is in state 2 (step S50).

Until the next distance L between the coils based on the extreme value of power reception voltage VR is set, vehicle ECU 500 updates distance L between the coils based on the movement distance of the vehicle calculated from the number of rotations (rotation speeds) of the driving wheel or the motor that drives the driving wheel. Vehicle ECU 500 controls notifying device 520 to notify distance L between the coils.

Next, vehicle ECU 500 determines whether the local maximum of power reception voltage VR has been detected or not during rearward movement of vehicle 10 (step S60). The local maximum of power reception voltage VR can be detected by detecting change in polarity of a differential value of power reception voltage VR. If the local maximum of power reception voltage VR has been detected during rearward movement of vehicle 10 (YES in step S60), vehicle ECU 500 sets distance L between the coils at X2 (step S70) and determines that distance L between the coils is in state 3 (step S80).

Next, vehicle ECU 500 determines whether the local minimum of power reception voltage VR has been detected or not during rearward movement of vehicle 10 (step S90). The local minimum of power reception voltage VR can also be detected by detecting change in polarity of a differential value of power reception voltage VR. If the local minimum of power reception voltage VR has been detected during rearward movement of vehicle 10 (YES in step S90), vehicle ECU 500 sets distance L between the coils at X3 (step S100) and determines that distance L between the coils is in state 4 (step S110).

If the local maximum of power reception voltage VR has not been detected in step S60 (NO in step S60) and if it is determined that distance L between the coils is larger than X1 (YES in step S120), vehicle ECU 500 determines that distance L between the coils is in state 1 (step S130). Thereafter, vehicle ECU 500 returns the process to step S20.

If the local minimum of power reception voltage VR has not been detected in step S90 (NO in step S90) and if it is determined that distance L between the coils is larger than X2 (YES in step S140), vehicle ECU 500 moves the process to step S50 and determines that distance L between the coils is in state 2.

If it is determined in step S20 that vehicle 10 is not moving rearward (NO in step S20), vehicle ECU 500 determines whether vehicle 10 is moving frontward or not (step S150). If vehicle 10 is not moving frontward (NO in step S150), the process is returned to step S20. If it is determined in step S150 that vehicle 10 is moving frontward (YES in step S150), vehicle ECU 500 determines whether power reception voltage VR is higher than a threshold value or not (step S160). This threshold value is for detecting rising of power reception voltage VR when distance L between the coils is X6. If power reception voltage VR exceeds the threshold value (YES in step S160), vehicle ECU 500 sets distance L between the coils at X6 (step S170). Thereafter, vehicle ECU 500 moves the process to step S220 shown in FIG. 8 and determines that distance L between the coils is in state 6.

Referring to FIG. 8, if it is determined in step S110 that distance L between the coils is in state 4, vehicle ECU 500 determines whether vehicle 10 has moved rearward further and the local minimum of power reception voltage VR has been detected or not (step S180). If the local minimum of power reception voltage VR has been detected during rearward movement of vehicle 10 (YES in step S180), vehicle ECU 500 sets distance L between the coils at X4 (step S190) and determines that distance L between the coils is in state 5 (step S200).

Next, vehicle ECU 500 determines whether distance L between the coils is smaller than X5 or not (step S210). If it is determined that distance L between the coils is smaller than X5 (YES in step S210), vehicle ECU 500 determines that distance L between the coils is in state 6 (step S220). Subsequently, vehicle ECU 500 determines whether distance L between the coils is smaller than X6 or not (step S230). If it is determined that distance L between the coils is smaller than X6 (YES in step S230), vehicle ECU 500 determines that distance L between the coils is in state 7 (step S240). Thereafter, if vehicle 10 moves frontward and power reception voltage VR exceeds the threshold value (YES in step S250), vehicle ECU 500 moves the process to step S220 and determines that distance L between the coils is in state 6.

If the local minimum of power reception voltage VR has not been detected in step S180 (NO in step S180), vehicle ECU 500 determines whether vehicle 10 has moved frontward and the local minimum of power reception voltage VR has been detected or not (step S260). If the local minimum of power reception voltage VR has been detected (YES in step S260), vehicle ECU 500 sets distance L between the coils at X3 (step S270). Thereafter, vehicle ECU 500 moves the process to step S80 shown in FIG. 7 and determines that distance L between the coils is in state 3.

If it is determined in step S210 that distance L between the coils is equal to or larger than X5 (NO in step S210), vehicle ECU 500 determines whether vehicle 10 has moved frontward and the local minimum of power reception voltage VR has been detected or not (step S280). If the local minimum of power reception voltage VR has been detected (YES in step S280), vehicle ECU 500 sets distance L between the coils at X4 (step S290). Thereafter, vehicle ECU 500 moves the process to step S110 shown in FIG. 7 and determines that distance L between the coils is in state 4.

If it is determined in step S230 that distance L between the coils is equal to or larger than X6 (NO in step S230), vehicle ECU 500 determines whether vehicle 10 has moved frontward and the local maximum of power reception voltage VR has been detected or not (step S300). If the local maximum of power reception voltage VR has been detected (YES in step S300), vehicle ECU 500 sets distance L between the coils at X5 (step S310). Thereafter, vehicle ECU 500 moves the process to step S200 and determines that distance L between the coils is in state 5.

As described above, in this first embodiment, when the local minimum value of power reception voltage VR is detected based on the measurement result by measuring device 210, notifying device 520 notifies the user of distance L between the coils corresponding to this local minimum value of power reception voltage VR. Distance L between the coils when power reception voltage VR has the local minimum value can be detected with a high degree of accuracy, based on the power reception voltage characteristic (FIG. 4) predetermined with respect to distance L between the coils. Therefore, according to this first embodiment, the user can be notified of highly-accurate information about distance L between the coils.

### Second Embodiment

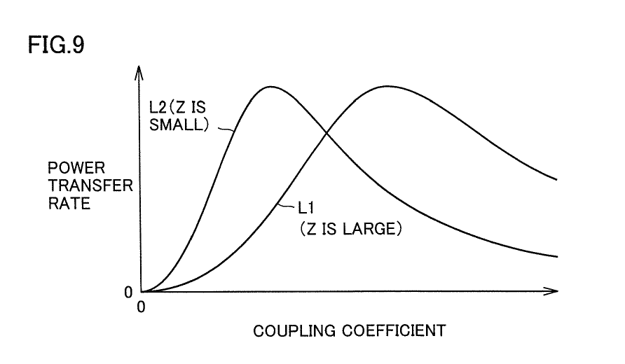

FIG. 9 is a diagram showing relation between a coupling coefficient and a power transfer rate when a resistance value of resistance 211 of measuring device 210 is large and when the resistance value of resistance 211 of measuring device 210 is small. Referring to FIG. 9, the vertical axis indicates the power transfer rate between the coils. Assuming that the electric power transmitted from power transmission unit 700 is fixed, it is recognized that change in power transfer rate indicates change in power reception voltage VR.

A curved line L1 indicates the case in which the resistance value of resistance 211 is large, and a curved line L2 indicates the case in which the resistance value of resistance 211 is small. In an area of small coupling coefficient, the power transfer rate is higher when the resistance value of resistance 211 is small than when the resistance value is large. Based on this, by setting the resistance value of resistance 211 to be small, the power transfer rate when distance L between the coils is long (coupling coefficient is small) can be increased, and it becomes possible to detect power reception voltage VR at a more distant location and detect distance L between the coils.

The rectifying unit is generally provided with the smoothing capacitor. This capacitor reduces fluctuation of power reception voltage VR, and thus, when the resistance value of resistance 211 is large, there is a possibility that the local minimum point of power reception voltage VR does not appear clearly when vehicle 10 moves (when distance L between the coils changes). In view of the detection range of distance L between the coils and detection of the local minimum point of power reception voltage VR, it is preferable that the resistance value of resistance 211 is small.

On the other hand, in an area of large coupling coefficient, the power transfer rate is higher when the resistance value of resistance 211 is large than when the resistance value is small. This means that, as the resistance value becomes larger, a distinction can be made more easily by the power transfer rate (power reception voltage VR) between the time when power reception unit 100 directly faces power transmission unit 700 (distance L between the coils=0 and the coupling coefficient is large) and the time when power reception unit 100 is displaced from the directly facing position (distance between the coils is not equal to 0 and the coupling coefficient is small). When the resistance value is small, the power transfer rate becomes lower as the coupling coefficient becomes larger. This is considered to be due to an influence of mutual inductance between power reception unit 100 and power transmission unit 700.

Thus, the resistance value of the resistance of the measuring device is made variable, and until the local minimum value of power reception voltage VR is at least detected, the resistance value is set to be small. As a result, wide-range detection of distance L between the coils is achieved and detection of the local minimum point of power reception voltage VR becomes easier. In the vicinity of the position where the coils directly face each other, the resistance value is set to be large. As a result, the accuracy of detecting position displacement can be increased. In this second embodiment, when alignment is executed, the resistance value of the resistance of the measuring device is set to be small during movement of vehicle 10 (during execution of alignment), and the resistance value is set to be large when vehicle 10 stops (alignment is completed).

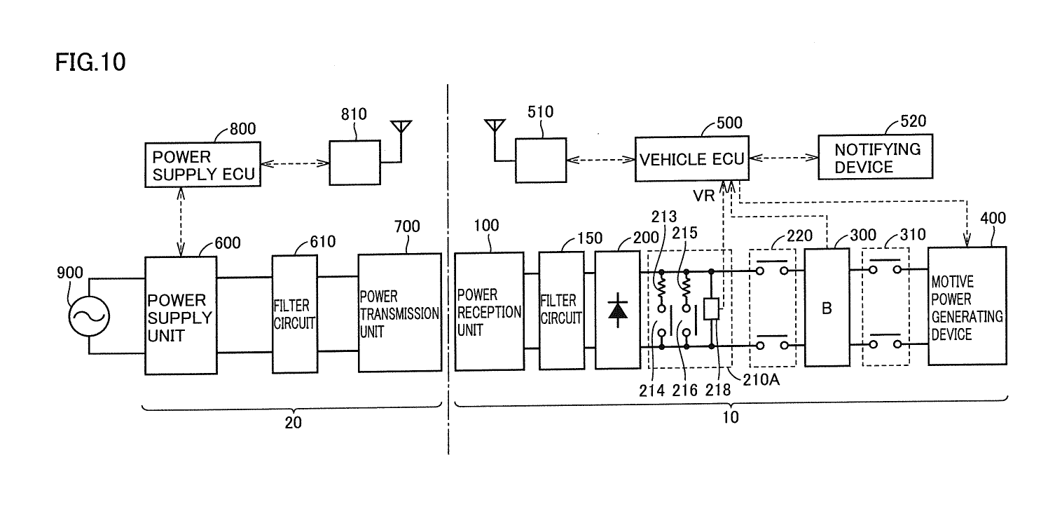

FIG. 10 is an overall configuration diagram of a power transfer system to which a power reception device according to the second embodiment is applied. Referring to FIG. 10, vehicle 10 in this power transfer system is different from vehicle 10 in the first embodiment shown in FIG. 1 in that a measuring device 210A is included instead of measuring device 210. Measuring device 210A includes resistances 213 and 215, relays 214 and 216, and voltage sensor 218.

Resistance 213 and relay 214 are provided between the pair of output lines of rectifying unit 200, and are serially connected. Resistance 215 and relay 216 are also provided between the pair of output lines of rectifying unit 200, and are serially connected. A resistance value of resistance 215 is smaller than a resistance value of resistance 213. When alignment is executed, relay 214 is turned off and relay 216 is turned on (relay 220 is turned off) by vehicle ECU 500 during movement of vehicle 10 (during execution of alignment). When vehicle 10 stops (alignment is completed), relay 214 is turned on and relay 216 is turned off by vehicle ECU 500. Namely, during movement of vehicle 10 related to execution of alignment, resistance 215 having the resistance value smaller than that of resistance 213 is used to detect distance L between the coils. When alignment is completed and vehicle 10 stops, resistance 213 having the resistance value larger than that of resistance 215 is used to detect (check) distance L between the coils.

The other configuration of vehicle 10 is the same as that of vehicle 10 in the first embodiment shown in FIG. 1. In addition, the configuration of power transmission device 20 is the same as that of power transmission device 20 in the first embodiment shown in FIG. 1.

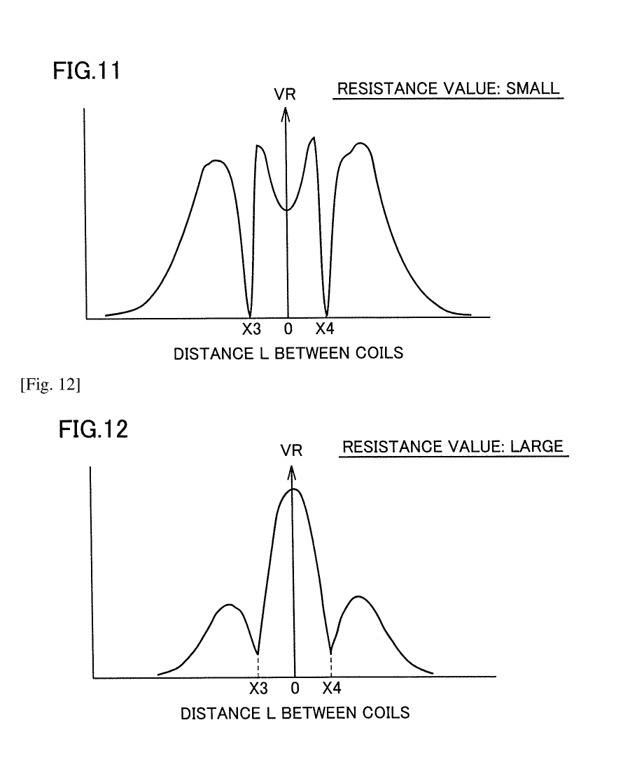

FIG. 11 is a diagram showing relation between distance L between the coils and power reception voltage VR when the resistance value of measuring device 210A is small. On the other hand, FIG. 12 is a diagram showing relation between distance L between the coils and power reception voltage VR when the resistance value of measuring device 210A is large.

Referring to FIGS. 11 and 12, the sensitivity of power reception voltage VR is higher when the resistance value of measuring device 210A is small, i.e., when resistance 215 is electrically connected in measuring device 210A (FIG. 11) than when the resistance value of measuring device 210A is large, i.e., when resistance 213 is electrically connected in measuring device 210A (FIG. 12). Specifically, power reception voltage VR can be detected with respect to larger distance L between the coils when the resistance value of measuring device 210A is small than when the resistance value is large, and the detection range of distance L between the coils is larger. In addition, the local minimum value of power reception voltage VR when distance L between the coils is X3 and X4 appears more clearly when the resistance value is small, and detection is easier.

On the other hand, in the range of X3<L<X4 where distance L between the coils is small, when the resistance value of measuring device 210A is small, the characteristic of power reception voltage VR is distorted (the maximum peak is divided into two) due to the influence of mutual inductance between the coils, and thus, detection of distance L between the coils based on power reception voltage VR is difficult. On the other hand, when the resistance value of measuring device 210A is large, the distortion occurring when the resistance value is small does not occur, and detection of distance L between the coils based on power reception voltage VR is easy.

Thus, in this second embodiment, the resistance value of measuring device 210A is set to be small when vehicle 10 moves. As a result, the detection range of distance L between the coils is expanded and detection of the local minimum point of power reception voltage VR is made easier. When vehicle 10 stops after alignment is completed, the resistance value of measuring device 210A is set to be large.

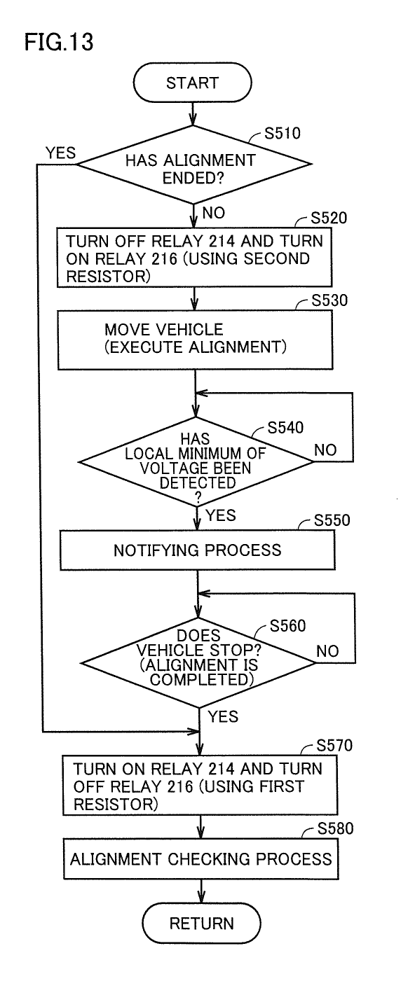

FIG. 13 is a flowchart for describing a procedure for switching between resistances 213 and 215 of measuring device 210A when alignment is executed. Referring to FIG. 13, vehicle ECU 500 first determines whether alignment between the coils has ended or not (step S510). If alignment has ended (YES in step S510), the process proceeds to step S570 described below.

If it is determined that alignment has not ended (NO in step S510), vehicle ECU 500 turns off relay 214 and turns on relay 216 (FIG. 10) (step S520). As a result, resistance 215 (second resistor) having the small resistance value is electrically connected. At this time, relay 220 is turned off. In this state, vehicle 10 is moved and alignment is executed based on the measurement value of power reception voltage VR (step S530). The alignment method is basically the same as that in the aforementioned first embodiment. In this second embodiment, during movement of vehicle 10, resistance 215 having the small resistance value is used in measuring device 210A to estimate distance L between the coils. Control of vehicle 10 when alignment is executed may be automatically executed based on distance L between the coils, or may be executed by the driver.

During execution of alignment, vehicle ECU 500 determines whether the local minimum of power reception voltage VR has been detected or not (step S540). If the local minimum of power reception voltage VR has been detected (YES in step S540), vehicle ECU 500 detects distance L between the coils when power reception voltage VR is minimum, by using the power reception voltage characteristic shown in FIG. 11, and performs the notification process for controlling notifying device 520 to notify detected distance L between the coils (step S550). Thereafter, when vehicle 10 stops and alignment is completed (YES in step S560), vehicle ECU 500 turns on relay 214 and turns off relay 216 (step S570). As a result, resistance 213 (first resistor) having the large resistance value is electrically connected in measuring device 210A.

Thereafter, using the power reception voltage characteristic shown in FIG. 12, vehicle ECU 500 detects distance L between the coils based on power reception voltage VR detected using resistance 213, and performs the process for checking alignment based on detected distance L between the coils (step S580). The case is also assumed in which charging is not started immediately after alignment is completed (e.g., the case in which charging is executed at a prescribed time in the middle of the night). This alignment checking process is for checking alignment, for example, immediately before charging is started. When this alignment checking process is performed, vehicle 10 is in the stop state, and in this second embodiment, resistance 213 having the large resistance value is used in measuring device 210A to detect distance L between the coils.

In the foregoing description, measuring device 210A is configured such that two resistances 213 and 215 are used to switch the resistance value. However, a variable resistance may be used to make the resistance value switchable.

As described above, according to this second embodiment, wide-range measurement of distance L between the coils is possible, and the user can be notified of highly-accurate information about distance L between the coils even when distance L between the coils is short (when vehicle 10 is in the stop state after alignment ends).

### First Modification of Second Embodiment

In the aforementioned second embodiment, during movement of vehicle 10, resistance 215 having the small resistance value is used in measuring device 210A to detect distance L between the coils, and during stop of vehicle 10, resistance 213 having the large resistance value is used to detect distance L between the coils. However, during execution of alignment, resistance 215 may be used to detect distance L between the coils, and during alignment checking after alignment is completed, resistance 213 may be used to detect distance L between the coils.

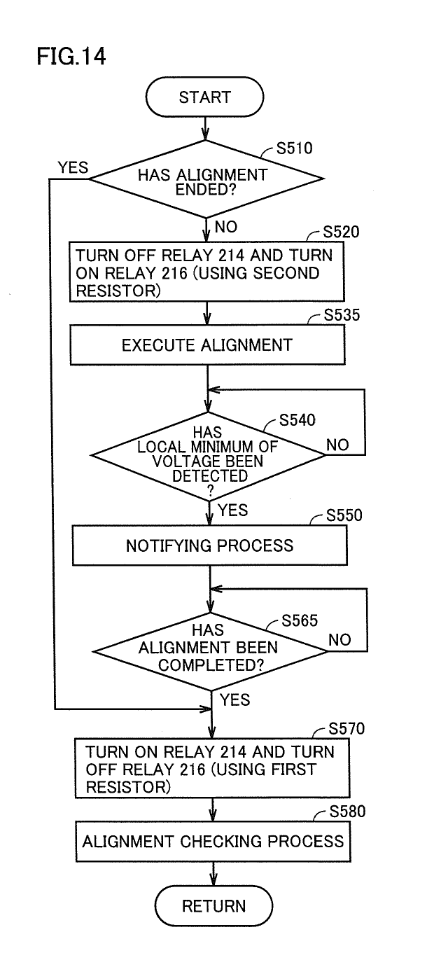

FIG. 14 is a flowchart for describing a procedure for switching between resistances 213 and 215 of measuring device 210A in a first modification of the second embodiment. Referring to FIG. 14, this flowchart is different from the flowchart shown in FIG. 13 in that steps S535 and S565 are included instead of steps S530 and S560, respectively.

Specifically, if relay 214 (FIG. 10) is turned off and relay 216 (FIG. 10) is turned on in step S520, alignment is executed based on the measurement value of power reception voltage VR (step S535). The alignment method is basically the same as that in the aforementioned first and second embodiments.

In step S550, the notification process for notifying distance L between the coils when power reception voltage VR is minimum is performed. Thereafter, if it is determined that alignment has been completed (YES in step S565), the process proceeds to step S570, and relay 214 is turned on and relay 216 is turned off. The other processing in the flowchart is the same as that in the second embodiment.

According to this first modification of the second embodiment as well, wide-range measurement of distance L between the coils is possible, and the user can be notified of highly-accurate information about distance L between the coils even when distance L between the coils after completion of alignment is short.

### Second Modification of Second Embodiment

In the aforementioned first modification, the resistance value of measuring device 210A is switched after alignment is completed. However, the resistance value of measuring device 210A may be switched when the local minimum point of power reception voltage VR is detected.

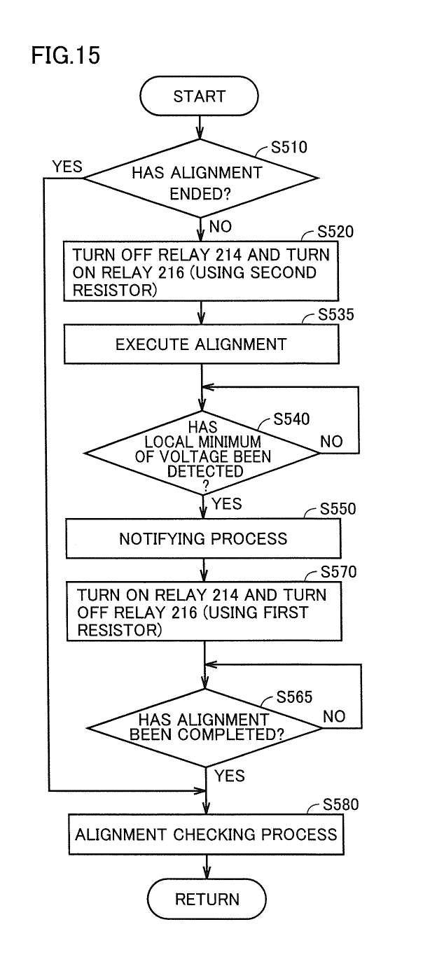

FIG. 15 is a flowchart for describing a procedure for switching between resistances 213 and 215 of measuring device 210A in a second modification of the second embodiment. Referring to FIG. 15, this flowchart is different from the flowchart shown in FIG. 14 in that the order of processing in step S565 and step S570 is interchanged.

Specifically, if the notification process for notifying distance L between the coils when power reception voltage VR is minimum is performed in step S550, vehicle ECU 500 turns on relay 214 (FIG. 10) and turns off relay 216 (FIG. 10) (step S570). As a result, the resistance used in measuring device 210A is switched from resistance 215 having the small resistance value to resistance 213 having the large resistance value.

Thereafter, if it is determined that alignment has been completed (YES in step S565), the process proceeds to step S580 and the alignment checking process is performed based on distance L between the coils detected by using resistance 213 having the large resistance value.

According to this second modification of the second embodiment as well, wide-range measurement of distance L between the coils is possible, and the user can be notified of highly-accurate information about distance L between the coils even when distance L between the coils is short.

It is intended to combine as appropriate and practice the embodiments disclosed herein. It should be understood that the embodiments disclosed herein are illustrative and not limitative in any respect. The scope of the present invention is defined by the terms of the claims, rather than the description of the embodiments above, and is intended to include any modifications within the scope and meaning equivalent to the terms of the claims.

### REFERENCE SIGNS LIST

10 vehicle; 20 power transmission device; 30 parking frame; 100 power reception unit; 150, 610 filter circuit; 200 rectifying unit; 210, 210A measuring device; 211, 213, 215 resistance; 212, 214, 216, 220, 310 relay; 218 voltage sensor; 300 power storage device; 400 motive power generating device; 500 vehicle ECU; 510, 810 communication device; 520 notifying device; 600 power supply unit; 700 power transmission unit; 800 power supply ECU; 900 external power supply.

1. A power reception device which is mounted on a vehicle and receives, in a contactless manner, electric power output from a power transmission device provided outside said vehicle, the power reception device comprising:
a power reception coil configured to receive, in a contactless manner, the electric power output from a power transmission coil of said power transmission device;
a measuring device configured to, when a distance between said power transmission coil and said power reception coil is detected based on a power reception voltage at the time of said power reception coil's reception of the electric power output from said power transmission coil, measure said power reception voltage;
a notifying device configured to notify said distance based on a measurement result by said measuring device, and
a distance calculator configured to calculate a movement distance of the vehicle,
said power reception coil being configured such that a characteristic of said power reception voltage with respect to said distance has a plurality of extreme values in accordance with change in said distance,
when said measuring device detects a local minimum value of said power reception voltage after detecting a rising of said power reception voltage, said notifying device being configured to notify a predetermined first distance corresponding to the detected local minimum value,
after detecting the local minimum value of said power reception voltage, said notifying device being configured to notify a distance calculated based on the first distance and a movement distance calculated by said distance calculator.

2. The power reception device according to claim 1, wherein said measuring device includes:
a resistance unit through which a current generated at said power reception coil at the time of reception of the electric power from said power transmission coil flows; and
a voltage sensor configured to detect a voltage generated at said resistance unit,
a resistance value of said resistance unit is switchable between a first resistance value and a second resistance value which is smaller than said first resistance value, and
in the case of moving said vehicle and executing alignment between said power transmission coil and said power reception coil based on said distance, the resistance value of said resistance unit is set at said second resistance value until the local minimum value of said power reception voltage is at least detected based on the measurement result by said measuring device.

3. The power reception device according to claim 2, wherein when said distance is detected during movement of said vehicle with execution of said alignment, the resistance value of said resistance unit is set at said second resistance value, and
when said distance is detected during stop of said vehicle, the resistance value of said resistance unit is set at said first resistance value.

4. The power reception device according to claim 2, wherein during execution of said alignment, the resistance value of said resistance unit is set at said second resistance value, and
when said distance is detected after the end of said alignment, the resistance value of said resistance unit is set at said first resistance value.

5. The power reception device according to claim 2, wherein when the local minimum value of said power reception voltage is detected based on the measurement result by said measuring device during execution of said alignment, the resistance value of said resistance unit is set at said first resistance value.

6. The power reception device according to claim 2, wherein said resistance unit includes:
a first resistor having said first resistance value; and
a second resistor having said second resistance value, said second resistor and said first resistor being selectively used.

7. The power reception device according to claim 2, wherein the number of said extreme values when the resistance value of said resistance unit is said second resistance value is larger than the number of said extreme values when the resistance value of said resistance unit is said first resistance value.

8. The power reception device according to claim 1, wherein said power reception coil includes:
a winding; and
a core around which said winding is wound, and
said power reception coil is mounted on said vehicle such that a winding axis of said winding extends along a frontward-rearward direction of said vehicle.

9. A vehicle comprising the power reception device as recited in claim 1.
